(19) United States
(12) Patent Application Publication
(10) Pub. No.: US 2007/0076007 A1
(43) Pub. Date: Apr. 5, 2007

(54) Display controller capable of reducing cache memory and the frame adjusting method thereof

(75) Inventor: Te-Yi Chen, Hualien City (TW)

Correspondence Address: RABIN & Berdo, PC, 1101 14TH STREET, NW, SUITE 500, WASHINGTON, DC, 20005, US

(73) Assignee: Quanta Computer Inc.

(21) Appl. No.: 11/475,157

(22) Filed: Jun. 27, 2006

(30) Foreign Application Priority Data
Sep. 21, 2005 (TW) 94132728

(51) Int. Cl. G09G 5/39

(52) U.S. Cl. 345/531

(57) ABSTRACT

A display controller capable of reducing cache memory and a frame adjusting method thereof are provided. The display controller comprises a memory controller, a first memory, a second memory and a frame control circuit. The memory controller is for reading part of the image data from a source layer to obtain a first image data, and reading part of the image data from the target layer to obtain a second image data. The first memory is for storing the first image data. The second memory is for storing the second image data. The frame control circuit is for processing the first image data to generate a first processed image data overlaid with the second image data to obtain a second processed image data. If the second processed image data needs further processing, then the display controller loads the second processed image data to an external memory.

This application claims the benefit of Taiwan application Serial No. 094132728, filed Sep. 21, 2005, the subject matter of which is incorporated herein by reference.

### BACKGROUND OF THE INVENTION

1. Field of the Invention

The invention relates in general to a display controller and a frame adjusting method thereof, and more particularly to a display controller capable of reducing cache memory and the frame adjusting method thereof.

2. Description of the Related Art

Along with the advance in science and technology, various electronic products have gradually become an indispensable part to modern people in their everyday life. However, display quality is very essential to consumers when it comes to the purchase of an electronic product. The display frame of an electronic product is normally achieved by processing and overlaying several layers. For example, a display frame may be achieved by overlaying a processed sub-layer with a main layer.

The above practice can be applied in displaying a function menu on an electronic device. The functions available to an electronic device are largely increased. To facilitate the user with the selection of the functions included in the function menu of an electronic device, nowadays the function menu is typically displayed on a display frame for the user to click and execute.

Referring to FIG. 1, a display controller is illustrated. The display controller 30 accesses an image data of a layer from an external memory 10 via a data bus 20. Examples of the external memory 10 include a synchronous dynamic random access memory (SDRAM). The image data of several layers are stored in the external memory 10. The display controller 30 reads and processes a layer from the external memory 10, overlays and outputs the image data of each processed layer to generate and display a frame on a display 40. The display controller 30 may rotate, mirror, enlarge, reduce or shift a layer, and then overlay the layer with another layer. In order to perform the above treatment, the display controller 30 has to randomly access the image data of each layer from the external memory 10. During the processing of each layer, a layer buffer having the same capacity as the frame of the display 40 is needed to store the in-process frame of the display controller 30.

If the layer buffer is disposed in the external memory 10, then when the in-process frame is to be processed, the display controller 30 needs to read the in-process frames from the layer buffer of the external memory 10 first. Since the accessing speed of the SDRAM is slow, the display controller 30 has to spend a long duration of time in accessing the layer buffer.

To avoid the above situation, a cache memory is disposed inside the display controller 30 as a layer buffer. The cache memory must be capable of storing the entire display frame. The display controller 30 stores the image data of the entire layer in the cache memory first, and then applies matrix operation to the image data. At last, the results of matrix operation and the image data are used to generate the needed display frame.

However, the layer buffer needs to store the entire display frame, so the cache memory requires a large capacity to store the entire display frame. Despite a large-capacity cache memory may reduce the accessing time of the display controller, the manufacturing cost of the conventional display controller is increased, hence reducing the competitiveness of the product.

### SUMMARY OF THE INVENTION

It is therefore an object of the invention to provide a display controller capable of reducing cache memory and a frame adjusting method thereof. By changing the design of the hardware of the display controller, the accessing time required for the display controller to access image data is shortened, the required capacity of the cache memory disposed in the display controller internal is reduced, and the manufacturing cost is reduced accordingly.

The invention achieves the above-identified object by providing a display controller capable of reducing cache memory. The display controller is electrically connected to an external memory. The external memory is used for storing a target layer and a source layer. The display controller comprises a memory controller, an internal memory and a frame control circuit. The memory controller is used for reading part of the image data from the source layer to obtain a first image data, and reading part of the image data from the target layer to obtain a second image data. The internal memory comprises a first memory and a second memory. The first memory is used for storing two rows of pixels of the first image data. The second memory is used for storing one row of pixels of the second image data. The frame control circuit processes the first image data to generate a first processed image data overlaid with the second image data stored in the second memory to obtain a second processed image data. If the second processed image data needs further processing, the display controller loads the second processed image data to the external memory.

The invention further achieves the above-identified object by providing a frame adjusting method capable of reducing the cache memory. The frame adjusting method is used for processing a source layer and a target layer stored in an external memory. The frame adjusting method is applied in a display controller. The display controller comprises a first memory and a second memory. The frame adjusting method comprises the following steps. At first, part of the image data is read from the source layer to obtain and store a first image data in the first memory. Next, part of the image data is read from the target layer to obtain and store a second image data in the second memory. Then, the first image data is processed to generate a first processed image data. Afterwards, the first processed image data is overlaid with the second image data stored in the second memory to obtain a second processed image data. At last, whether the second processed image data needs further processing is determined: if so, the second processed image data is loaded to the external memory.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates a display controller;

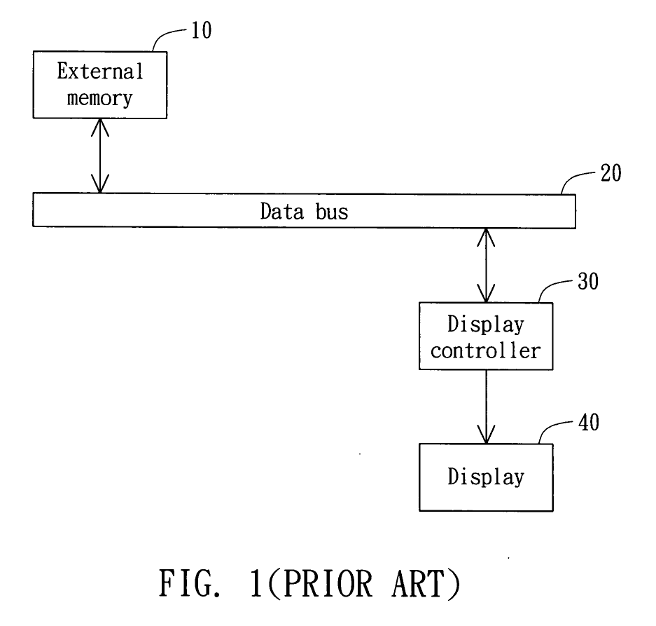

FIG. 2 illustrates a block diagram of a display controller according to the invention;

FIG. 3 illustrates respective image data of pixels in a source layer and a target layer;

FIG. 4A illustrates the source layer overlaid with the target layer;

FIG. 4B illustrates the source layer having been removed to overlay with the target layer with respect to FIG. 4A;

FIG. 5 illustrates the source layer having been leftward and rightward mirrored to overlay with the target layer with respect to FIG. 4A;

FIG. 6 illustrates the source layer having been rotated 90 degrees clockwise to overlay with the target layer with respect to FIG. 4A;

FIG. 7 illustrates the source layer having been enlarged to overlay with the target layer with respect to FIG. 4A; and

FIG. 8 illustrates a flowchart of a frame adjusting method according to the invention.

### DETAILED DESCRIPTION OF THE INVENTION

The function of the display controller is shifting, enlarging, reducing, mirroring or rotating the source layer, and then overlaying the source layer with the target layer. By changing hardware design without affecting the above functions, the internal memory of the display controller of the invention may effectively reduce the manufacturing cost of the display controller.

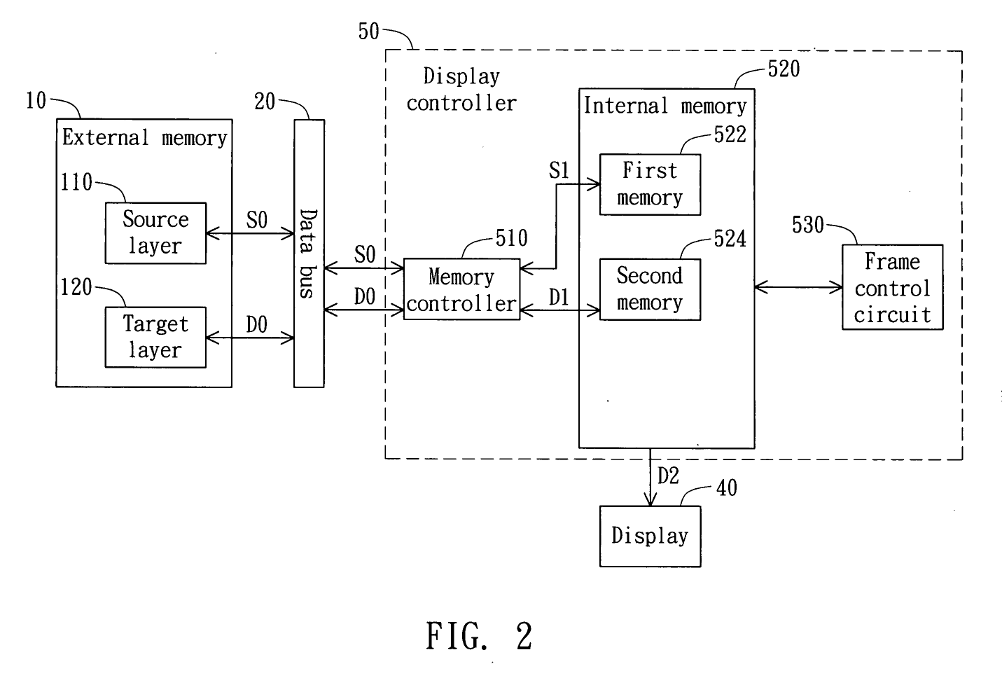

Referring to FIG. 2, a block diagram of a display controller according to the invention is illustrated. The display controller 50 accesses an image data from an external memory 10 via a data bus 20, processes the image data and then outputs the processed data to a display 40 having n columns of pixels×m rows of pixels to form a display frame having n columns of pixels×m rows of pixels, where n and m are positive integers. Examples of the external memory 10 include a synchronous dynamic random access memory (SDRAM). The external memory 10 has the image data of a target layer 120 and the image data of a source layer 110 stored therein. Examples of the target layer 120 include a background of the menu frame of a mobile phone. Examples of the source layer 110 include each selection item of the menu.

The display controller 50 comprises a memory controller 510, an internal memory 520 and a frame control circuit 530. The memory controller 510 selects and reads part of the image data D0 of the target layer 120 from the external memory 10 to generate a second image data D1. Examples of the second image data D1 include the image data of one row of the target layer 120. The memory controller 510 reads part of the image data S0 from the source layer 110 to generate a first image data S1. Examples of the first image data S1 include the image data of one row of the source layer 110. The frame control circuit 530 is capable of enlarging/reducing, rotating, mirroring and shifting the source layer 110, and capable of overlaying two layers.

Examples of the internal memory 520 include a cache memory. The internal memory 520 comprises a first memory 522 and a second memory 524. The first memory 522 and the second memory 524 of the internal memory 520, such as line buffers, do not need to store the entire display frame. The capacity of the first memory 522 is determined according to the maximum width of the source layer supported by the first memory 522. If the maximum width of the source layer is M, that is, each row of a source layer can have M pixels at maximum, then the first memory 522 can store up to 2M pixels. The capacity of the second memory 524 is determined according to the number of columns in the display frame of the display 40. The number of columns determines the number of pixels each row in a display frame can have. If a display frame has N columns, then each row of a display frame has N pixels. Therefore, if the cache memories 522 and 524 can respectively store two rows of pixels of the source layer and one row of pixels of the target layer, then the cache memories would be sufficient for the display controller 50 to process various treatments with respect to the layers. The first memory 522 is used for storing the first image data S1. The second memory 524 is used for storing the second image data D1.

The frame control circuit 530 processes the first image data S1 to generate a first processed image data S2 (not shown in the diagram) for the first processed image data S2 to be overlaid with the second image data D1 of the second memory 524 to obtain a second processed image data D2. When the second processed image data D2 of the second memory 524 needs further processing, the display controller 50 loads the second processed image data D2 to the external memory 10. If the second processed image data D2 does not need further processing, then the memory controller 510 outputs the second processed image data D2 to the display 40.

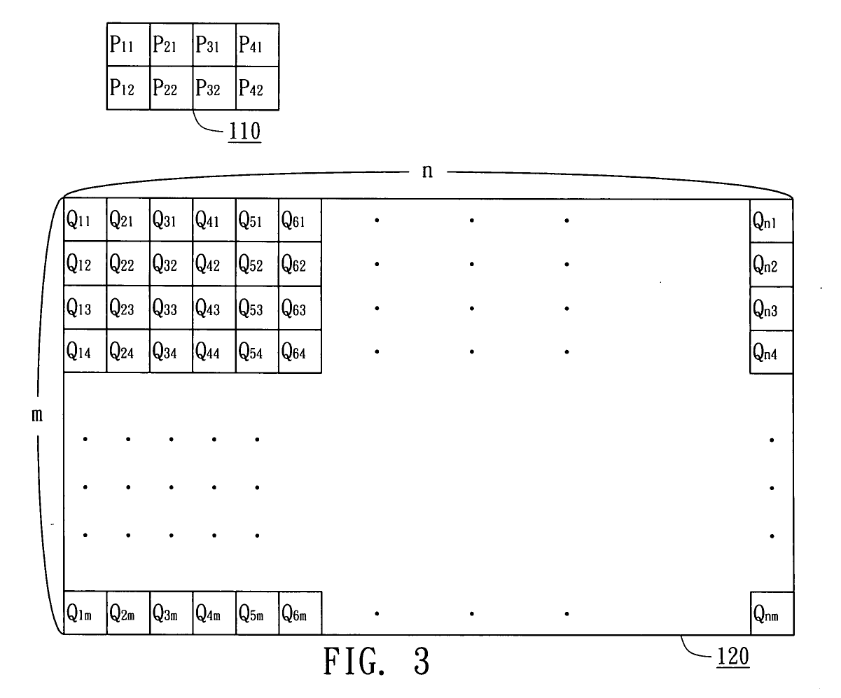

Referring to FIG. 3, respective image data of pixels in a source layer and a target layer are illustrated. Examples of the source layer 110 include a layer having 4 columns of pixels×2 rows of pixels. The image data of pixels in the first row are arranged from left to right in the order of P₁₁, P₂₁, P₃₁, and P₄₁. The image data of pixels in the second row are arranged from left to right in the order of P₁₂, P₂₂, P₃₂, and P₄₂. The target layer 120 is a layer having n columns of pixels×m rows of pixels. The image data of pixels in the first row are arranged from left to right in the order of Q₁₁, Q₂₁, Q₃₁˜Qₙ₁. The image data of pixels in the second row are arranged from left to right in the order of Q₁₂, Q₂₂, Q₃₂˜Qₙ₂. The arrangement from the third row to the m-th row can be obtained likewise. The image data of each pixel in the target layer 120 respectively corresponds to a pixel position. For example, the position of the image data of the pixel Q₂₂ at the second columns and the second row of the target layer 120 corresponds to the pixel position (2, 2). The display controller 50 overlays each processed pixel data of the source layer 110 with the target layer 120. The processing of the display controller 50 comprises enlarging/reducing, rotating, mirroring or shifting the source layer 110, and then overlaying with the target layer 120. The details are disclosed below.

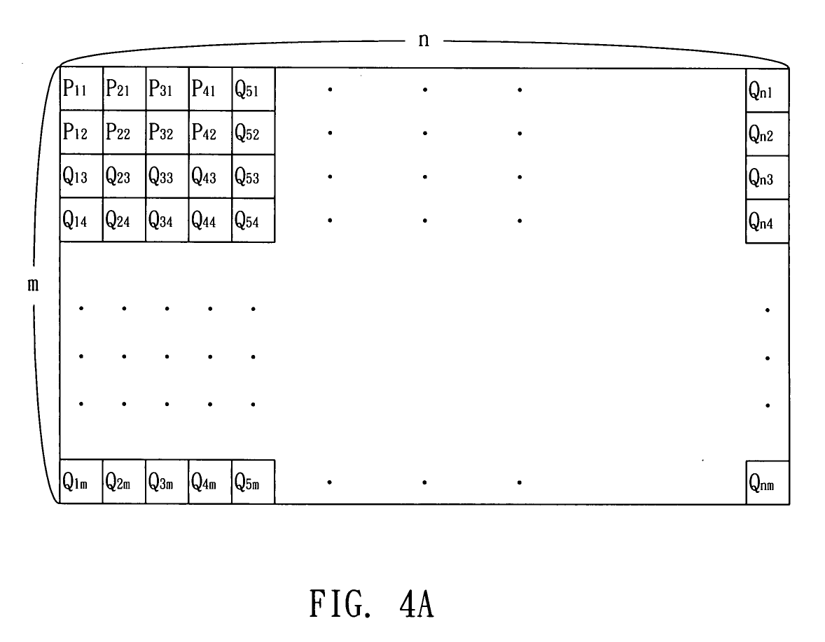

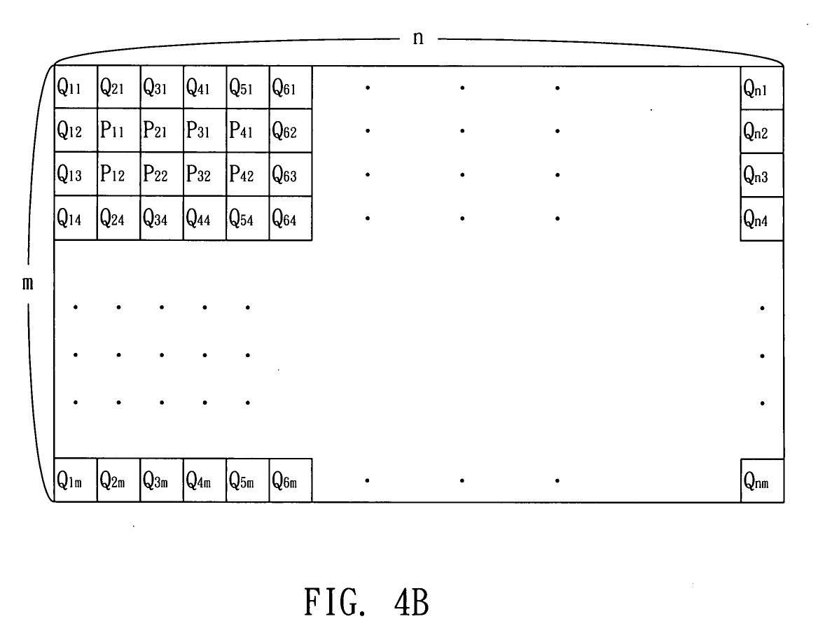

Referring to FIG. 4A and FIG. 4B. FIG. 4A illustrates the source layer overlaid with the target layer. FIG. 4B illustrates the source layer having been removed to overlay with the target layer with respect to FIG. 4A. Take FIG. 4B for example. If the source layer 110 having 4 columns of pixels×2 rows of pixels is to be overlaid with the target layer 120 having n columns of pixels×m rows of pixels, and overlays with the target layer 120 at the pixel positions of (2, 2), (3, 2), (4, 2), (5, 2), (2, 3), (3, 3), (4, 3) and (5, 3), respectively. The memory controller 510 of the display controller 50 sequentially reads the image data of pixels Q₁₁, Q₂₁˜Qₙ₁ from the first row of the target layer 120 via the data bus 20 to obtain and store the second image data D1 in the second memory 524. The memory controller 510 sequentially reads the image data of pixels P₁₁, P₂₁, P₃₁, and P₄₁ from the first row of the source layer 110 via the data bus 20 to obtain and store the first image data S1 in the first memory 522. Meanwhile, if the first image data S1 does not need further processing, then the first image data S1 is used as the first processed image data S2.

Since the image data of pixels P₁₁, P₂₁, P₃₁, and P₄₁ in the first row of the source layer 110 are to be overlaid with the second row of the target layer 120, the second row of the target layer 120 is the corresponding position of the source layer 110 in the target layer 120. Therefore, the frame control circuit 530 will not overlay the image data of pixels P₁₁, P₂₁, P₃₁, and P₄₁ in the first row of the source layer 110 with the image data in the first row of the target layer 120, but will directly use the second image data D1 of the target layer 120 as the second processed image data D2 and output the pixels in the first row of the target layer 120 to the display 40. Not until the memory controller 510 reads the image data of pixels Q₁₂, Q₂₂˜Qₙ₂ from the second row of the target layer 120 to obtain and store the second image data D1 in the second memory 524, the frame control circuit 530 overlays the first processed image data S2 with the second image data D1 of the second memory 524, sequentially starting from the second pixel Q₂₂ of the second image data D1 to obtain the second processed image data D2. The second processed image data D2 is the image data of pixels Q₁₂, P₁₁, P₂₁, P₃₁, P₄₁, Q₆₂˜Qₙ₂. The display controller 50 outputs the second processed image data D2 to the pixels in the second row of the display 40 to display an image. Likewise, the image data in the second row of the source layer 110 is overlaid with the image data in corresponding row of the target layer 120 to complete the treatment of overlaying the source layer with the target layer. As for the image data after the fourth row of the target layer, having no overlaying and requiring no further treatment, the image data after the fourth row of the target layer are processed in the same way with the image in the first row, and are directly outputted to be displayed in the display 40.

The treatment of shifting the source layer 110 to be overlaid with the target layer 120 is exemplified by overlaying the image data of the source layer 110 with the corresponding position of the shifted target layer 120. In this way, the display controller 50 completes the treatment of overlaying the shifted source layer 110 with the target layer 120.

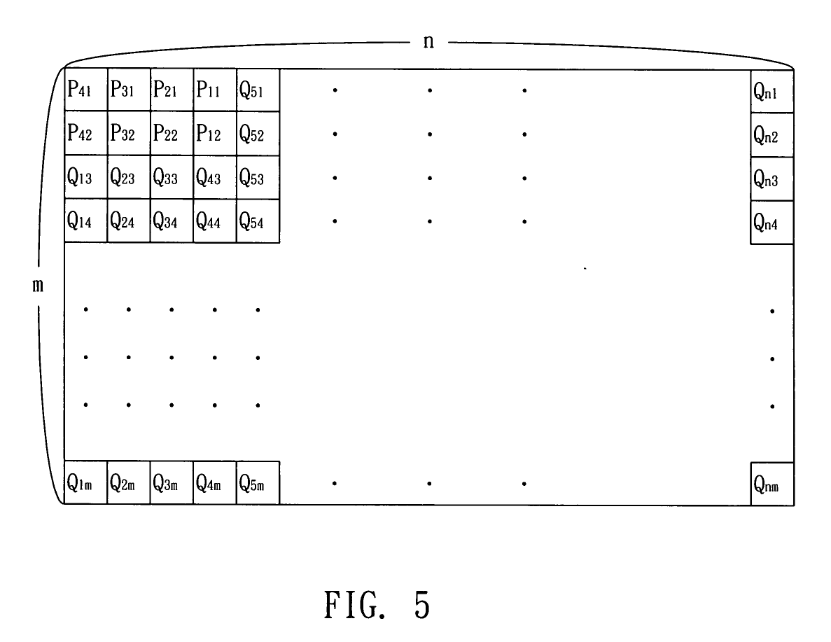

Referring to FIG. 5, the source layer having been leftward and rightward mirrored to overlay with the target layer with respect to FIG. 4A is illustrated. For example, if the source layer 110 is leftward and rightward mirrored to overlay with a target layer 120 having n columns of pixels×m rows of pixels, the image data of pixels P₁₁, P₂₁, P₃₁, P₄₁, P₁₂, P₂₂, P₃₂, and P₄₂ of the source layer 110 are respectively overlaid with the target layer 120 at the corresponding positions of (4, 1), (3, 1), (2, 1), (1, 1), (4, 2), (3, 2), (2, 2), and (1, 2). The memory controller 510 of the display controller 50 sequentially reads the image data of pixels Q₁₁, Q₂₁˜Qₙ₁ from the first row of the target layer 120 via the data bus 20 to obtain and store the second image data D1 in the second memory 524. In order to leftward and rightward mirror the source layer 110 to be overlaid with the target layer 120, the memory controller 510 reads the image data of pixels P₄₁, P₃₁, P₂₁, P₁₁, in the first row of the source layer 110 according to the sequence of the leftward and rightward mirrored source layer 110 via the data bus 20 to obtain the first image data S1. The first image data S1 is obtained by reversing the pixel sequence in the first row of the source layer 110. The display controller 50 and stores the first image data S1 in the first memory 522. If the first image data S1 does not need further processing, the first image data S1 is used as the first processed image data S2.

The frame control circuit 530 overlays the first processed image data S2 with the second image data D1 of the second memory 524, sequentially starting from the first pixel Q₁₁ of the second image data D1 to obtain the second processed image data D2. The display controller 50 outputs the second processed image data D2 to the pixels in the first row of the display 40 to display an image. Likewise, the image data in the second row of the source layer 110 is overlaid with the image data in corresponding row of the target layer 120 for the display controller 50 to complete the treatment of leftward and rightward mirroring the source layer, and then overlay the source layer with the target layer.

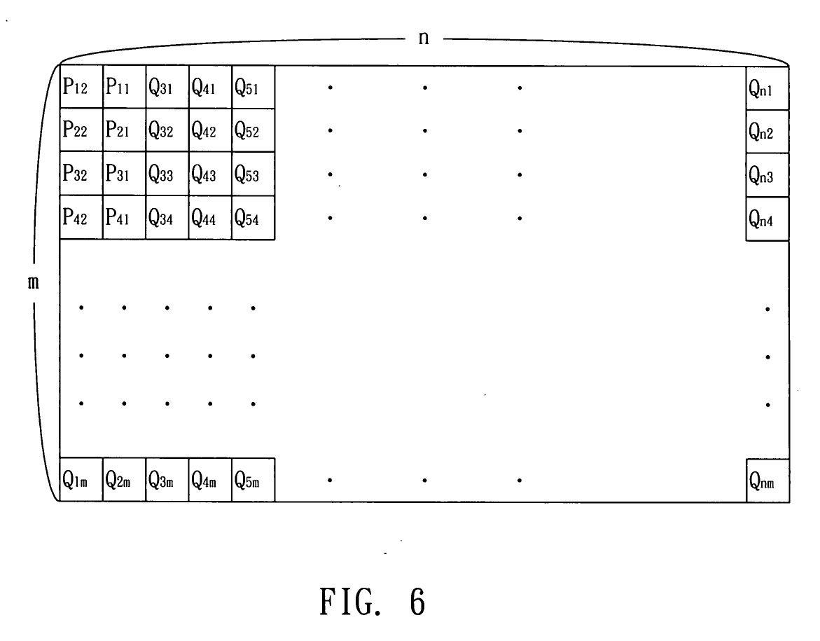

Referring to FIG. 6, the source layer having been rotated 90 degrees clockwise to overlay with the target layer with respect to FIG. 4A is illustrated. For example, the source layer 110 having 4 columns of pixels×2 rows of pixels is rotated 90 degrees clockwise to be overlaid with a target layer 120 having n columns of pixels×m rows of pixels. The source layer 110 is overlaid with the target layer 120 at the corresponding positions of (1, 1), (1, 2), (1, 3), (1, 4), (2, 1), (2, 2), (2, 3), (2, 4). The memory controller 510 of the display controller 50 sequentially reads the image data of pixels Q₁₁, Q₂₁˜Qₙ₁ from the first row of the target layer 120 via the data bus 20 to obtain and store the second image data D1 in the second memory 524. The memory controller 510, according to the sequence of the source layer 110 rotated 90 degrees clockwise, reads the image data of pixels P₁₂ and P₁₁ in the first column of the rotated source layer 110 via the data bus 20 to obtain and store the first image data S1 in the first memory 522. If the first image data S1 does not need further image processing, the first image data S1 is used as the first processed image data S2.

The frame control circuit 530 overlays the first processed image data S2 with the second image data D1 of the second memory 524, sequentially starting from the first pixel Q₁₁ of the second image data D1 to obtain the second processed image data D2. That is, the image data of pixels P₁₂, P₁₁ Q₃₁, Q₄₁˜Qₙ₁ in the first row of FIG. 6. The display controller 50 outputs the overlaid image data to the pixels in the first row of the display 40 to display an image. Likewise, the image data in each row of the source layer 110 is overlaid with the image data in corresponding row of the target layer 120 for the display controller 50 to complete the treatment of rotating the source layer 90 degrees clockwise to be overlaid with the target layer.

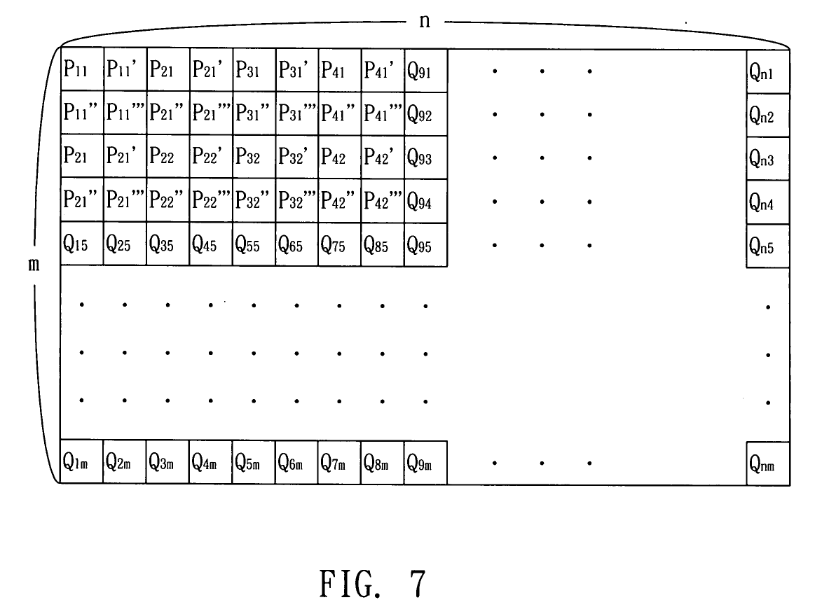

Referring to FIG. 7, the source layer having been enlarged to overlay with the target layer with respect to FIG. 4A is illustrated. Apart from the processing of mirroring, rotating, and shifting, the display controller 50 can enlarge/reduce the source layer 110 to be overlaid with the target layer 120. Since the enlargement/reduction needs linear interpolation of two rows of pixels of the source layer to obtain one row of processed image data, the first memory 522 has two rows of the image data of the source layer 110 at the same time. For example, if the source layer 110 having 4 columns of pixels×2 rows of pixels is enlarged by two times and then overlaid with a target layer 120 having n columns of pixels×m rows of pixels, the source layer 110 is overlaid with the target layer 120 at the positions of (1, 1), (2, 1), (3, 1), (4, 1), (5, 1), (6, 1), (7,1), (8, 1), (1, 2), (2, 2), (3, 2), (4, 2), (5, 2), (6, 2), (7, 2), (8, 2), (1, 3), (2, 3), (3, 3), (4, 3), (5, 3), (6, 3), (7, 3), (8, 3), (1, 4), (2, 4), (3, 4), (4, 4), (5, 4), (6, 4), (7, 4), (8, 4).

The memory controller 510 of the display controller 50 sequentially reads the image data of pixels Q₁₁, Q₂₁˜Qₙ₁ from the first row of the target layer 120 via the data bus 20 to obtain and store the second image data D1 in the second memory 524. The memory controller 510 reads the image data of pixels P₁₁, P₂₁, P₃₁, P₄₁ and P₁₂, P₂₂, P₃₃, P₄₂ respectively in the first row and the second row of the source layer 110 via the data bus 20 to obtain and store the two rows of the image data S1 in the first memory 522.

Through linear interpolation, the frame control circuit 530 sequentially determines the first image data S2 of each pixel overlaid in the corresponding row of the target layer from left to right. For example, the pixel P₁₁, is overlaid with the pixels Q₁₁, P₁₁′ overlaid with the pixel Q₂₁ is obtained from the interpolation of the pixels P₁₁ and P₂₁, and likewise. The frame control circuit 530 overlays the first processed image data S2 with the second image data D1 of the second memory 524, sequentially starting from the first pixel Q₁₁ of the second image data D1 to obtain a second processed image data D2. Meanwhile, the second processed image data D2 does not needs further processing, so the display controller 50 outputs the second processed image data D2 to the pixels in the first row of the display 40 to display an image.

Next, the memory controller 510 of the display controller 50 sequentially reads the image data of pixels Q₁₂, Q₂₂˜Qₙ₂ from the second row of the target layer 120 via the data bus 20 to obtain and store the second image data D1 in the second memory 524. It is the result of interpolation of the first row and the second row of the source layer that will overlay with the second row of the target layer. Since the first row and the second row are already stored in the first memory 522, there is no need to read the source layer again. Through linear interpolation, the frame control circuit 530 inserts the image data of the simulated pixel between the image data of the first row and the image data of the second row of the source layer 110, so that the image data obtained by using the first processed image data S2 as the simulated pixel is P₁₁″, P₁₁′″, P₂₁″, P₂₁′″, P₃₁″, P₃₁′″, P₄₁″and P₄₁′″. The frame control circuit 530 overlays the first processed image data S2 with the second image data D1 of the second memory 524, sequentially starting from the first pixel Q₁₂ of the second image data D1 to obtain a second processed image data D2. The display controller 50 outputs the second processed image data D2 to the pixels in the second row of the display 40 to display an image. Likewise, the image data in each row of the source layer 110 is overlaid with the image data in corresponding row of the target layer 120 for the display controller 50 to complete the treatment of enlarging the source layer by two times to be overlaid with the target layer.

As disclosed above, the display controller 50 performs the treatment of enlarging/reducing, rotating, mirroring or shifting the source layer 110 to be overlaid with the target layer. However, the number of source layer is not limited to one. The display controller 50 can perform the treatment of enlarging/reducing, rotating, mirroring or shifting more than one source layer 110 to be overlaid with the target layer. If the processed image data D2 still needs to be overlaid with further layer overlaying or needs other treatments, then the processed image data D2 is outputted to the external memory 10.

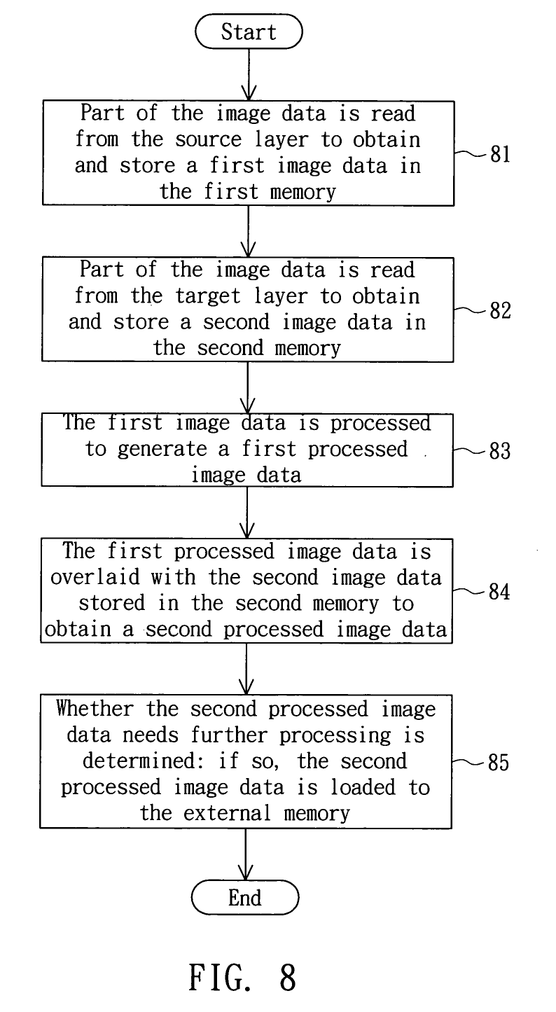

Referring to FIG. 8, a flowchart of a frame adjusting method according to the invention is illustrated. The frame adjusting method is used for processing a source layer and a target layer of an external memory. The frame adjusting method is applied in a display controller. The display controller comprises a first memory and a second memory. The frame adjusting method comprises the following steps. At first, as shown in step 81, part of the image data the source layer 110 is read to obtain and store the first image data S1 in the first memory 522. Next, as shown in step 82, part of the image data the target layer 120 is read to obtain and store the second image data D1 in the second memory 524. Afterwards, as shown in step 83, the first image data S1 is processed to generate a first processed image data S2. Then, as shown in step 84, the first processed image data S2 is overlaid with the second image data D1 of the second memory 524 to obtain a second processed image data D2. At last, as shown in step 85, whether the second processed image data D2 needs further processing is determined: if so, load the second processed image data to the external memory 10; if not, the second processed image data is outputted to the display 40. Examples of the second image data D1 include the image data in one row of the target layer. Examples of the first image data S1 include the image data in one row or one column of a source layer.

A display controller capable of reducing cache memory and a frame adjusting method are disclosed in above embodiments of the invention. Through the circuit design disclosed above, the cache memory of the display controller does not need to store the entire display frame. According to the invention, the capacity of the cache memory of the display controller only needs to store one row of display frame, hence contributing to bringing the manufacturing cost down.

Furthermore, the invention improves the efficiency in reading data. When reading the source layer, the memory controller also rotates at the same time, so that each layer only has one occurrence of non-continuous reading at most during reading. Therefore, the efficiency in reading data from the external memory by the memory controller is improved.

While the invention has been described by way of example and in terms of a preferred embodiment, it is understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display controller electrically connected to an external memory, wherein the external memory is used for storing a target layer and at least a source layer, and the display controller comprises:
a memory controller used for reading part of the image data from the source layer to obtain a first image data, and reading part of the image data from the target layer to obtain a second image data;
an internal memory, comprising:
a first memory used for storing the first image data; and
a second memory used for storing the second image data; and
a frame control circuit used for processing the first image data to generate a first processed image data overlaid with the second image data stored in the second memory to obtain a second processed image data;
wherein, if the second processed image data needs further processing, then the display controller loads the second processed image data to the external memory.

2. The display controller according to claim 1, wherein the second image data includes one row of image data of the target layer.

3. The display controller according to claim 2, wherein the first image data includes one row of image data of the source layer.

4. The display controller according to claim 1, wherein when the display controller is to adjust the size of the source layer to overlay with the target layer, the display controller stores the first image data in the first memory, the frame control circuit adjusts the size of the first image data stored in the first memory to generate a first processed image data, and overlays with the second image data stored in the second memory to obtain a second processed image data.

5. The display controller according to claim 1, wherein the source layer has the capacity of M column pixels, the first memory has the capacity of 2M pixels, and M is a positive integer.

6. The display controller according to claim 1, wherein the target layer has the capacity of N column pixels, the second memory has the capacity of N pixels, and N is a positive integer.

7. The display controller according to claim 1, wherein if the display controller is to rotate the source layer to overlay with the target layer, the first image data is obtained by the sequence of the rotated source layer and includes one column of image data of the rotated source layer, the first image data is used as the first processed image data, and the second image data includes one row of image data of the target layer.

8. The display controller according to claim 1, wherein when the display controller is to leftward and rightward mirror the source layer to overlay with the target layer, the first image data is obtained by reversing the pixel sequence in one row of image data of the source layer, the first image data is used as the first processed image data, and the second image data includes one row of image data of the target layer.

9. The display controller according to claim 1, wherein if the display controller is to shift the source layer to overlay with a corresponding position of the target layer, and the second image data read by the memory controller corresponds to the corresponding position, the first image data is used as the first processed image data and the frame control circuit overlays the first processed image data with the second image data in the corresponding position.

10. The display controller according to claim 1, wherein the external memory includes a synchronous dynamic random access memory (SDRAM).

11. The display controller according to claim 1, wherein when the second processed image data does not need to be processed, the memory controller outputs the second processed image data stored in the second memory to be displayed in a display.

12. A frame adjusting method applied in a display controller for processing a source layer and a target layer of an external memory, wherein the frame adjusting method comprises:
reading part of the image data from the source layer to obtain a first image data, and storing the first image data in a first memory of the display controller;
reading part of the image data from the target layer to obtain a second image data, and storing the second image data in a second memory of the display controller;
processing the first image data to generate a first processed image data;
overlaying the first processed image data with the second image data stored in the second memory to obtain a second processed image data; and
determining whether the second processed image data needs further processing: if so, loading the second processed image data to the external memory.

13. The frame adjusting method according to claim 12, wherein the second image data includes one row of image data of the target layer.

14. The frame adjusting method according to claim 13, wherein the first image data includes one row of image data of the source layer.

15. The frame adjusting method according to claim 12, wherein if the source layer is adjusted to overlay with the target layer, the overlaying step comprises:
storing the first image data in the first memory;
adjusting the size of the first image data stored in the first memory to generate a first processed image data; and
overlaying the first processed image data with the second image data stored in the second memory.

16. The frame adjusting method according to claim 12, wherein the source layer has the capacity of M column pixels, the first memory has the capacity of 2M pixels, and M is a positive integer.

17. The frame adjusting method according to claim 12, wherein the target layer has the capacity of N column pixels, the capacity of the second memory has N pixels, and N is a positive integer.

18. The frame adjusting method according to claim 12, wherein if the source layer is rotated to overlay with the target layer, the first image data is obtained by the sequence of the rotated source layer and includes one column of the image data of rotated the source layer, the first image data is used as the first processed image data, and the second image data includes one row of image data of the target layer.

19. The frame adjusting method according to claim 12, wherein if the source layer is leftward and rightward mirrored to overlay with the target layer, the first image data is obtained by reversing the pixel sequence in one row of image data of the source layer, the first image data is used as the first processed image data, and the second image data includes one row of image data of the target layer.

20. The frame adjusting method according to claim 12, wherein if the display controller is to shift the source layer to overlay with a corresponding position of the target layer, when the second image data corresponds to the corresponding position, the display controller reads the source layer to obtain the first image data, and uses the first image data to be the first processed image data to overlay with the second image data in the corresponding position.

21. The frame adjusting method according to claim 12, wherein the target layer has the capacity of N column pixels, the first memory and the second memory have the capacity of N pixels, and N is a positive integer.

22. The frame adjusting method according to claim 12, wherein the external memory includes a synchronous dynamic random access memory (SDRAM).

23. The frame adjusting method according to claim 12, wherein in the step of determining whether the second processed image data needs further processing, if the second processed image data does not need further processing, then the display controller outputs the second processed image data to be displayed in a display.
